(19) United States
(12) Patent Application Publication
(10) Pub. No.: US 2016/0373816 A1
(43) Pub. Date: Dec. 22, 2016

(54) AUTOMATION TESTING APPARATUS

(71) Applicant: Telefonaktiebolaget LM Ericsson (publ), Stockholm (SE)

(72) Inventors: Sandesh KASHIKAR, Austin, TX (US); Ronald KEEBLE, San Carlos, CA (US); Brad HOLMES, San Jose, CA (US); Swapnesh CHAUBAL, Sunnyvale, CA (US); Anand JOSHI, Campbell, CA (US); Juan FLORES, Santa Clara, CA (US); Ward SHELLEY, Tracy, CA (US)

(21) Appl. No.: 15/132,129

(22) Filed: Apr. 18, 2016

Related U.S. Application Data
(60) Provisional application No. 62/180,569, filed on Jun. 16, 2015.

(51) Int. Cl. H04N 21/4425; H04N 21/4223; H04N 21/6543; H04N 21/4363; H04N 21/443

(52) U.S. Cl. CPC H04N 21/4425; H04N 21/43635; H04N 21/443; H04N 21/6543; H04N 21/4223

(57) ABSTRACT

An automation testing apparatus includes a controller that is configured to receive a set of one or more commands that are part of a test and programmatically manipulate a set of components that connect the automation testing apparatus with a device under test (DUT) to test the DUT according to the set of commands The set of components may include a power switch that is configured to turn on and off power to the DUT, a communication controller that is configured to send commands to be executed by the DUT, and an audio/video switch that is configured to turn on and off audio and/or video of the DUT. The controller logs the set of commands executed and a result of execution of the set of commands to analyze whether the test passed.

### CROSS-REFERENCE TO RELATED APPLICATIONS

This application claims the benefit of U.S. Provisional Application No. 62/180,569, filed Jun. 16, 2015, which is hereby incorporated by reference.

### FIELD

Embodiments of the invention relate to the field of testing electronic devices; and more specifically, to an automation testing apparatus.

### BACKGROUND

Tests are commonly performed when software is upgraded or changed to ensure that the software upgrade/change does not cause unexpected results. Many of these tests are historically performed manually and require significant time and expense. For instance, in the case of upgrading/changing software of a set-top box (STB), there can be thousands of test operations manually performed and verified, for each unique STB running that software. Example categories of testing performed for a STB include testing the power connection (power on/off, standby on/off), testing the High-Definition Multimedia Interface (HDMI) connection, testing commands to control the STB (e.g., Infrared commands, Bluetooth commands), testing audio and/or video quality, and testing the software to verify that it is operating as expected. These tests are typically manually intensive. For instance, testing the HDMI connection historically required someone to physically unplug and plug in the HDMI cable many times. As another example, some tests typically required a person physically watching a display connected to the STB in order to verify that the correct display and/or quality of display is being produced.

### SUMMARY

In an embodiment, an automation testing apparatus includes a controller that is configured to receive a set of one or more commands that are part of a test and programmatically manipulate a set of components that connect the automation testing apparatus with a device under test (DUT) to test the DUT according to the set of commands The set of components may include a power switch that is configured to turn on and off power to the DUT, a communication controller that is configured to send commands to be executed by the DUT, and an audio/video switch that is configured to turn on and off audio and/or video of the DUT. The controller logs the set of commands executed and a result of execution of the set of commands to analyze whether the test passed.

### BRIEF DESCRIPTION OF THE DRAWINGS

The invention may best be understood by referring to the following description and accompanying drawings that are used to illustrate embodiments of the invention. In the drawings:

FIG. 1 is a block diagram that illustrates exemplary components of the automation testing system according to one embodiment;

FIG. 2 is a block diagram that illustrates an exemplary embodiment of the automation testing apparatus that is connected to a device under test according to one embodiment;

FIG. 3 illustrates an example log that has been presented for review according to one embodiment;

FIG. 4 is a block diagram illustrating exemplary operations of the automated testing apparatus according to one embodiment;

FIG. 5 illustrates exemplary operations for analyzing the result to determine whether the test passed or failed according to one embodiment; and

FIG. 6 illustrates an example of placing an Internet Protocol (IP) probe among multiple places in the network for analyzing the quality of experience of the captured audio/visual (AV) stream at different points in the network according to one embodiment.

### DESCRIPTION OF EMBODIMENTS

In the following description, numerous specific details are set forth. However, it is understood that embodiments of the invention may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

Bracketed text and blocks with dashed borders (e.g., large dashes, small dashes, dot-dash, and dots) are used herein to illustrate optional operations that add additional features to embodiments of the invention. However, such notation should not be taken to mean that these are the only options or optional operations, and/or that blocks with solid borders are not optional in certain embodiments of the invention.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An automation testing apparatus is described herein. The automation testing apparatus is configured to programmatically manipulate one or more components that connect the automation testing apparatus with a device under test (DUT) in response to set of one or more commands The set of components may include one or more of: the power connection of a device under test (DUT), an audio/video connection of the DUT (e.g., an HDMI connection of the DUT), a communication controller of the DUT (e.g., Infrared control of the DUT, Bluetooth low energy (BLE) control of the DUT, and a camera to take images and/or video of a display connected to the DUT. In one embodiment, the automation testing apparatus may be targeted at audio/video (AV) endpoints that decode an AV stream and utilize HDMI/High-Bandwidth Digital Content Protection (HDCP) to encapsulate the AV stream between an HDMI-compliant source endpoint designed to render video and the AV stream sourced from a managed or unmanaged network.

In one embodiment, the automation testing apparatus is adapted to be connected to the DUT and includes one or more of the following: a set of relays to turn on/off the DUT; a linear actuator or electronic switch to turn HDMI on/and off; an Infrared (IR) emitter to control the DUT through IR commands; an IR receiver to record IR codes; a Bluetooth emitter to control the DUT through Bluetooth commands; a Bluetooth receiver to record Bluetooth codes; a camera to take pictures and/or video of the DUT or a display connected to the DUT; a capture card to capture the video being processed by the DUT; one or more controllers that receive commands and control the set of relays, the linear actuator or electronic switch, the IR emitter, the IR receiver, the Bluetooth emitter, the Bluetooth receiver, the camera, and/or the capture card; and software to perform the tests and/or analyze the results of the tests.

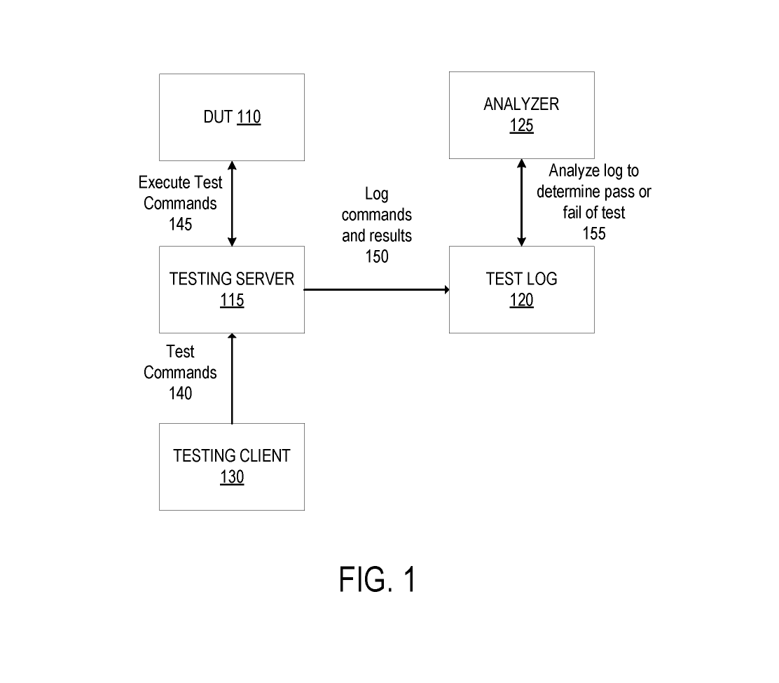

FIG. 1 is a block diagram that illustrates exemplary components of the automation testing system according to one embodiment. The system includes the DUT 110, which may be a workstation, laptop, portable medial player, gaming system, set top box, global positioning system (GPS) unit, smartphone, Internet enabled appliance, etc. The testing server 115 is connected to the DUT 110 and the testing client 130. The testing client 130 communicates test commands 140 for the testing server 115 to execute. The testing client 130 may be executed on a workstation, laptop, smartphone, or other computing device. The testing client 130 may transmit the test commands 140 using RESTful application program interfaces (APIs). For instance, a user can use a web browser of the testing client 130 to specify individual commands to the testing server 115 using PUT requests. As another example, the testing client 130 may be a testing script that is converted into commands that are communicated to the testing server 115.

The testing server 115 is configured to execute the test commands 145 that are received from the testing client 130. As part of executing the test commands, the testing server 115 may programmatically manipulate components for testing of the DUT 110, such as the power, the AV interface, and Infrared control and/or BLE control, according to the received test commands 140. The testing server 115 is configured to log 150 the test commands and results of the commands to the test log 120. The analyzer 125 is configured to access the test log 120 and analyze 155 the log to determine whether a particular test has passed or failed. In one embodiment, the analyzer 125 may be located on the same physical device as the testing server 115. In another embodiment, the analyzer 125 may be a separate computing device that is located remotely from the testing server 115.

In one embodiment, the test log 120 is located on the same physical device as the testing server 115. In another embodiment, the test log 120 is located on a device that is remote from the testing server 115. For instance, the test log 120 may be located on a server that allows access to other devices other than the testing server 115.

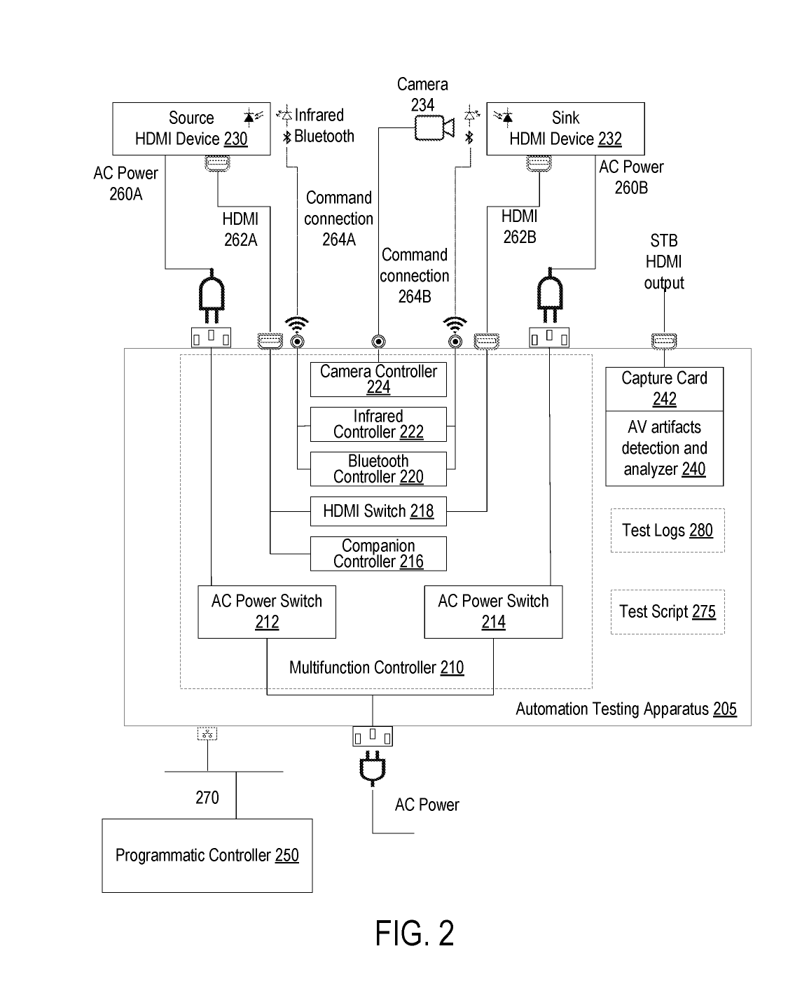

FIG. 2 is a block diagram that illustrates an exemplary embodiment of the automation testing apparatus that is connected to a DUT according to one embodiment. In the example shown in FIG. 2, the automation testing apparatus 205 is connected to the source HDMI device 230 and the sink HDMI device 232, which may both be a DUT. The source HDMI device 230 may be, for example, a set-top box; and the sink HDMI device 232 may be, for example, a television or other display. The source HDMI device 230 is connected to the automation testing apparatus 205 by an HDMI cable 262A and a power cable 260A and the sink HDMI device 232 is connected to the automation testing apparatus 205 by the HDMI cable 262B and the power cable 260B. The HDMI connection to the source HDMI device 230 and the sink HDMI device 232 maintains the HDCP digital rights management (DRM) encryption.

The automation testing apparatus 205 is also wirelessly connected to the source HDMI device 230 through the command connection 264A, which may be for example, an Infrared connection or a Bluetooth connection; and also wirelessly connected to the sink HDMI device 232 through the command connection 264B, which may also be through an Infrared connection or a Bluetooth connection. The automation testing apparatus 205 is also connected to the programmatic controller 250, through the network 270. The network 270 may be a local network or may be a wide area network (e.g., across the Internet).

The automation testing apparatus 205 programmatically manipulates certain components for automated testing of the device under test. For instance, the automation testing apparatus 205 includes the multifunction controller 210 that executes software to accept commands for testing and controls the alternating current (AC) power switches 212 and 214, the HDMI switch 218, the Bluetooth (BT) controller 220, the Infrared (IR) controller 222, the camera controller 224, and the capture card 242. The multifunction controller 210 receives commands from the programmatic controller 250 and/or through a test script loaded onto the automation testing apparatus 205. With respect to FIG. 1, the multifunction controller 210 executes software to act as the testing server 115.

The AC power switches 212 and 214 are configured to turn off/on power to the source HDMI device 230 and the sink HDMI device 232 respectively. The AC power switches may be relays that can be turned on/off based on commands received from the multifunction controller 210. The AC power switches 212 and 214 may also be configured to put the source HDMI device 230 and/or the sink HDMI device 232 into a standby power mode, if supported by that particular HDMI device, based on commands received from the multifunction controller 210. Turning on/off power to the source HDMI device 230 and/or the sink HDMI device 232 may be part of a test. For example, one test may include the multifunction controller 210 causing the AC power switch 212 to put the source HDMI device 230 into standby mode, wait for an amount of time, and the multifunction controller 210 causing a command to be transmitted to the source HDMI device 230 (e.g., through the command connection 264A) to turn back on, to analyze whether the source HDMI device 230 successfully enters standby mode and turns back on upon command. Another example test may include the multifunction controller 210 causing the AC power switch 212 to turn off power to the source HDMI device 230, waiting for an amount of time, and causing the AC power switch 212 to turn on power to the source HDMI device 230, to analyze whether the source HDMI device 230 successfully turned back on.

The HDMI switch 218 is configured to turn on/off the HDMI connection to the source HDMI device 230 and the sink HDMI device 232, by mechanically decoupling the input and output to simulate the removal and reinsertion of an HDMI cable. In one embodiment the HDMI switch 218 is a linear actuator that is used to press an HDMI switch to turn the HDMI on and off. In another embodiment, the HDMI switch 218 is an electronic HDMI switch that is configured to turn on/off the HDMI connections. Turning on/off the HDMI connection to the source HDMI device 230 and/or the sink HDMI device 232 may be part of tests that are run. For instance, an example test is an HDMI hotplug test that includes the multifunction controller 210 causing the HDMI switch 218 to turn HDMI off, waiting for an amount of time (e.g., 1-5 seconds), and turning the HDMI on; and repeating this cycle a number of times; and checking whether the audio and video return. Another test that may turn on/off the HDMI connection is a HDMI high severity test that includes the multifunction controller 210 causing the HDMI switch 218 to turn HDMI off and on a number of times in short succession, and repeating this cycle a number of times, and checking whether the audio and video return. Use of the automation testing apparatus 205 honors HDCP and therefore does not require the end user to sign a fair use and nondisclosure form with a registering agency before use.

The Bluetooth controller 220 is configured to control a Bluetooth connection to the source HDMI device 230 and/or the sink HDMI device 232. The Bluetooth controller 220 may include a Bluetooth emitter to transmit commands to the source HDMI device 230 through the command connection 264A and/or the sink HDMI device 232 through the command connection 264B. For instance, in the case that the source HDMI device 230 is a set-top box and the sink HDMI device 232 is a television that supports receiving commands from a Bluetooth enabled device (such as a Bluetooth enabled remote control), the Bluetooth controller 220 may transmit commands to the source HDMI device 230 through the command connection 264A and/or transmit commands to the sink HDMI device 232 through the command connection 264B. Example commands for a set-top box include the following: rewind, fast forward, stop, pause, play, skip backward, skip forward, record, guide, video on demand, digital video recorder, menu, up, down, left, right, info, select, exit, back, clear, enter, options, power off, power on, alternate audio, aspect ratio, search, slower, faster, quit, play/pause, delete, next, help, favorites, teletext, closed captions, system information, volume up, volume down, mute, channel up, channel down, last, and numbers (0-9). Example commands for a television include the following: power on, power off, input, volume up, volume down, channel up, channel down, menu, up, down, left, right, info, select, exit, back, clear, and numbers (0-9). Of course these are example commands and different commands may be transmitted and may be different depending on the type of source HDMI device 230 and/or sink HDMI device 232 and what commands are supported by the devices. The particular command that that is transmitted depends on the commands received from the programmatic controller 250 and/or the test script 275.

The Infrared controller 222 is configured to control an Infrared connection to the source HDMI device 230 and/or the sink HDMI device 232. The Infrared controller 222 may include an Infrared emitter to transmit commands to the source HDMI device 230 through the command connection 264A and/or the sink HDMI device 232 through the command connection 264B. The commands sent by the Infrared controller 222 may be similar to the commands sent by the Bluetooth controller 220. The Infrared controller 222 may include an Infrared receiver to record IR codes that may be used for transmitting commands to the source HDMI device 230 and/or the sink HDMI device 232. The Infrared controller 222 also supports IR code profiles that contain IR codes for various source HDMI devices and/or sink HDMI devices.

The camera controller 224 is configured to control the camera 234 to record images and/or videos captured by the camera 234 of the sink HDMI device 232. In practice, the tester may position the camera 234 so that the images and/or videos captured by the camera 234 will be that displayed by the sink HDMI device 232. The captured images and/or videos are used for tests involving the display of content.

The companion controller 216 is configured to accept commands from client devices (e.g., a laptop, smartphone, tablet, etc.) and send them to the source HDMI device 230 (e.g., through the High-Bandwidth Digital Content Protection (HDCP) protocol over the HDMI connection.

The programmatic controller 250 executes code to send commands to the automation testing apparatus 205. The programmatic controller 250 may be a client device (e.g., a laptop or desktop computer, a tablet, a smartphone, etc.) and connected to the automation testing apparatus 205 by the network 270. With respect to FIG. 1, the programmatic controller 250 acts as the testing client 130. The commands may be sent to the automation testing apparatus 205 through the use of RESTful APIs. For instance, a user can use a web browser of the programmatic controller 250 to specify individual commands to the automation testing apparatus 205 using PUT requests. Alternatively, the programmatic controller 250 may execute and/or transmit to the automation testing apparatus 205 a test script, which is a series of commands If executing the test script, the programmatic controller 250 parses the test script and sends the commands to the automation testing apparatus 205 in the order that they appear in the script. If transmitting the test script, the multifunction controller 210 parses the test script and executes the commands in the order that they appear in the script. The test script allows for the use of variables, loops, procedure calls and comments. The same test script can be used for different source HDMI device and/or sink HDMI devices, only by changing the variable names (e.g., through the use of profiles).

The capture card 242 is configured to capture the audio/video (AV) stream being output by the source HDMI device 230 (e.g., through the HDMI cable 262A) and executes code to separate the captured AV stream into multiple frames. The AV artifacts detection and analyzer 240 executed by the capture card 242 to determine whether the captured AV stream is suffering from a loss of signal (e.g., causing pixelation) or has other integrity issues.

The code executing on the programmatic controller 250 interacts with code executing on the automation testing apparatus 205. For example, the multifunction controller 210 may execute code for a webserver, which accepts commands to drive the various components in the automation testing apparatus 205. In one embodiment, the software executing on the multifunction controller 210 can be controlled from any location that can access the Internet protocol (IP) address of the webserver of the automation testing apparatus 205.

As described above, the code executing on the multifunction controller 210 drives many of the various hardware components of the automation testing apparatus 205. The executing code on the multifunction controller 210 may also log various commands and results of the commands The logging may be turned on and off by the tester. In one embodiment, the logs are stored on a server that is remote to the automation testing apparatus 205 such that the logs can be accessed by other devices other than the automation testing apparatus 205 (e.g., through a web page). In another embodiment, the logs are stored on the automation testing apparatus 205. As illustrated in FIG. 2, the automation testing apparatus 205 includes the test logs 280.

The logs may include a text log that includes each command that is received at the automation testing apparatus and each command that is executed by the automation testing apparatus 205. The text log may be stored on the test logs 280 and/or sent to a remote server. The logs may include an image log that includes images that are taken as part of the testing (e.g., taken by the camera 234). The image log may be stored on the test logs 280 and/or sent to a remote server. The logs may include a video log that includes that includes videos that are taken as part of the testing (e.g., taken by the camera 234). The video log may be stored on the test logs 280 and/or sent to a remote server.

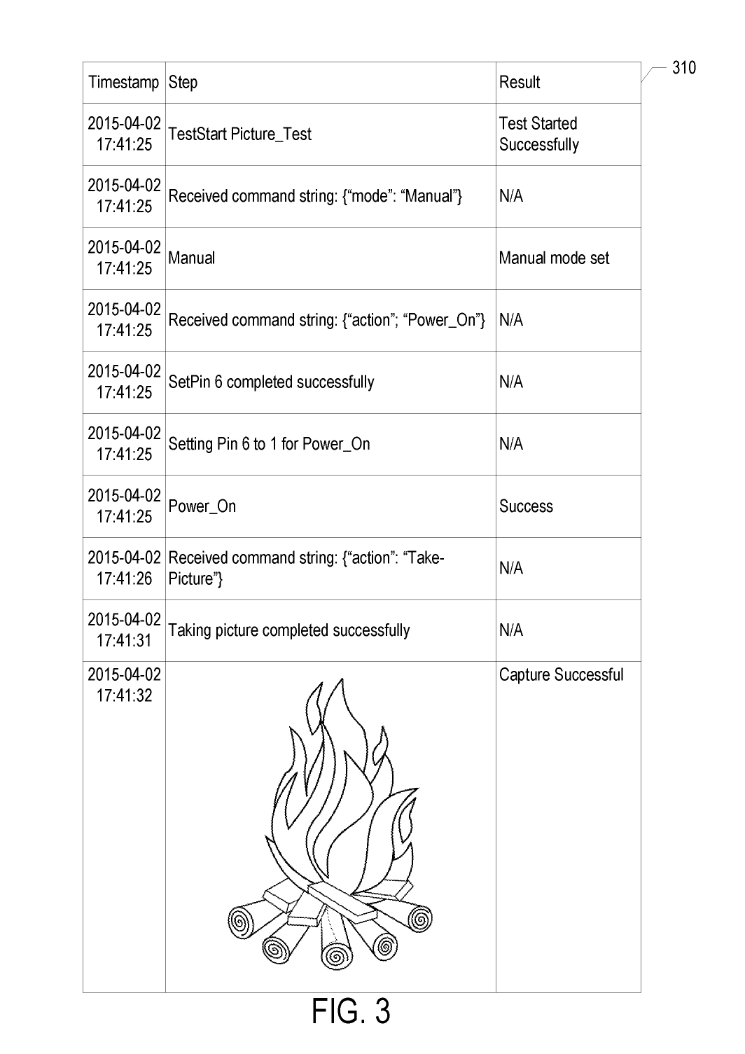

An example log 310 that has been parsed and presented for review is illustrated in FIG. 3. The log 310 shows each step and the result. In the example illustrated in FIG. 3, the log shows that three commands were received and the log shows the result of executing these commands The first command that was received was to put the DUT in manual mode, which was successful. The second command that was received was to power on the DUT, which was successful. The third command that was received was to take a picture, which was successful. The image that was taken is also included in the log such that a user reviewing the log can visually confirm that the image was taken.

In one embodiment, the testing may be scheduled to run at a given time and specified by the tester. For example, the tester may use the programmatic controller 250 to specify the test name, time, and frequency. The test will then be executed at the specified time and frequency and the results may be stored in the test logs 280 and/or transmitted to the remote logging server.

In one embodiment, optical character recognition (OCR) is used to determine test results. For example, a user may specify a command to use OCR to verify text of an image/video that is captured by the camera 234. As another example, OCR software may execute on the remote logging server to check the text and the result may be shown as part of the log along with the image.

Although the automation testing apparatus 205 is illustrated as being connected to DUT that incorporate HDMI, it should be understood that the automation testing apparatus 205 can be connected to DUTs through different connections, and may include different components accordingly. For instance, the DUT may not include HDMI but may include other technology for playing audio and/or video and the automation testing apparatus 205 may include component to manipulate that audio and/or video.

In a specific embodiment where the source HDMI device 230 is a set-top box and the sink HDMI device 232 is a television or other display, the following are examples of the types of test that can be performed using embodiments described herein: closed caption; audio level and loudness; AV—Soak test; high definition (HD) channel tune test; HD resolution test; HDMI/HDCP and device depth; HDMI test, LED light verification on STB, digital video recorder (DVR) pause buffer, network impairment, picture-in-picture, screen resolution/aspect ratio, smooth streaming tune/trick mode, STB standby/power cycles/hot plug/upgrade, tune times verification, video-on-demand, whole home DVR, zoom, HDCP compliance, electronic program guide (EPG) teletext, network address translation (NAT), HDMI interoperability, and active format description.

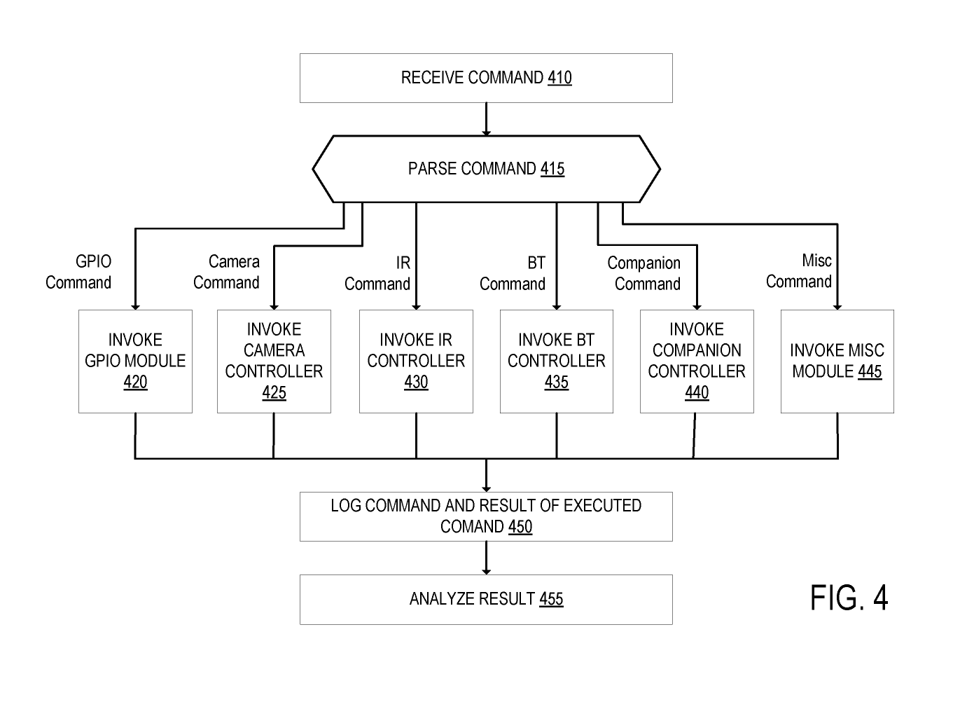

FIG. 4 is a block diagram illustrating exemplary operations of the automated testing apparatus according to one embodiment. FIG. 4 will be described with respect to the exemplary embodiment of FIG. 2. However, it should be understood that the exemplary embodiment of FIG. 2 can execute operations different than what is described in FIG. 4, and the operations described in FIG. 4 can be performed by embodiments other than those described with reference to FIG. 2.

At operation 410, the multifunction controller 210 receives a test command This test command may be received as a result of the multifunction controller 210 converting a test script into a set of commands Alternatively, this command may be received from the programmatic controller 250 or converted into a command from input received from the programmatic controller 250. Next, at operation 415, the multifunction controller 210 parses the command to determine the type of command

If the command is a general purpose I/O (GPIO) command, then flow moves to operation 420 where the multifunction controller 210 invokes the GPIO controller to execute the command For instance, if the command is to turn off HDMI to the source HDMI device 230, the multifunction controller 210 causes the HDMI switch 218 to turn off HDMI to the source HDMI device 230. As another example, if the command is to turn off power to the sink HDMI device 232, the multifunction controller 210 causes the AC power switch 214 to turn off power. Flow then moves to operation 450.

If the command is a camera command (e.g., take an image and/or video), then flow moves to operation 425 where the multifunction controller 210 invokes the camera controller 224 to execute the command For instance, if the command is to take an image, the multifunction controller 210 causes the camera controller 224 to take a picture using the camera 234. Flow then moves to operation 450.

If the command is an IR command, then flow moves to operation 430 where the multifunction controller 210 invokes the IR controller 222 to execute the command For example, if the command is to send a command through IR to the source HDMI device 230, the multifunction controller 210 causes the IR controller 222 to transmit the command to the source HDMI device 230 through the command connection 264A. Flow then moves to operation 450.

If the command is a BT command, then flow moves to operation 435 where the multifunction controller 210 invokes the BT controller 220 to execute the command For example, if the command is to send a command through Bluetooth to the source HDMI device 230, the multifunction controller 210 causes the BT controller 220 to transmit the command to the source HDMI device 230 through the command connection 264A. Flow then moves to operation 450.

If the command is a companion command, then flow moves to operation 440 where the multifunction controller 210 invokes the companion controller 216 to execute the command As an example, the companion controller 216 may send the command to the source HDMI device 230 through the HDCP protocol over the HDMI connection. Flow then moves to operation 450.

If the command is a miscellaneous command (it does not fit into the other categories shown in FIG. 4, for example), then flow moves to operation 445 and a miscellaneous module is invoked to execute the command Example miscellaneous commands include commands to set up scheduling of the tests. Flow then moves to operation 450.

At operation 450, the command and the result of the executed command is logged. In one embodiment, the logs are stored on a server that is remote to the automation testing apparatus 205 such that the logs can be accessed by other devices other than the automation testing apparatus 205 (e.g., through a web page). In another embodiment, the logs are stored on the automation testing apparatus 205 such as in the test logs 280. The type of information that is logged depends on the type of command (e.g., text, image, video). Flow then moves to operation 455.

At operation 455, the result of execution of the command is analyzed to determine whether the test passed or failed. In one embodiment, some tests require a human to analyze the log to determine whether the test passed while other tests can be analyzed automatically to determine whether the test has passed. For instance, if a test included checking whether the appropriate menu displayed correctly on the sink HDMI device 232, the log may be presented to the user with an image taken of the display of the sink HDMI device 232 at a time when the menu should be displayed. If the text of the menu is known, then OCR may be performed and the test may be automatically performed. If the menu displayed correctly, then the test passed. A test to check the frames-per-second (fps) may be analyzed automatically, as another example.

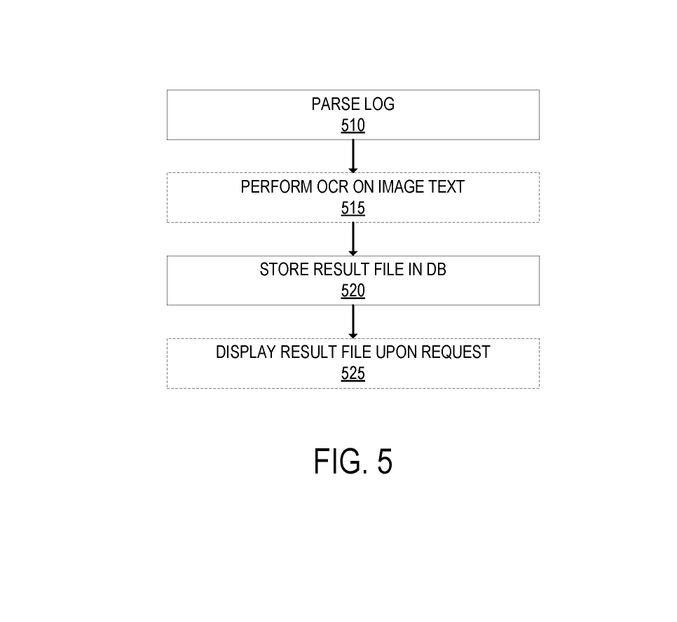

FIG. 5 illustrates exemplary operations for analyzing the result to determine whether the test passed or failed according to one embodiment. At operation 510, the test log is parsed to identify the individual commands Next, at operation 515, optical character recognition (OCR) is performed on the image text to identify the text in the image. Operation 515 is performed only if there is an image in the log. Next, at operation 520, the resulting parsed log is stored in a database or other data structure for access by a user. Next, at operation 525, the result file is displayed to a user upon request. By way of example, FIG. 3 illustrates such a result file for review by the user.

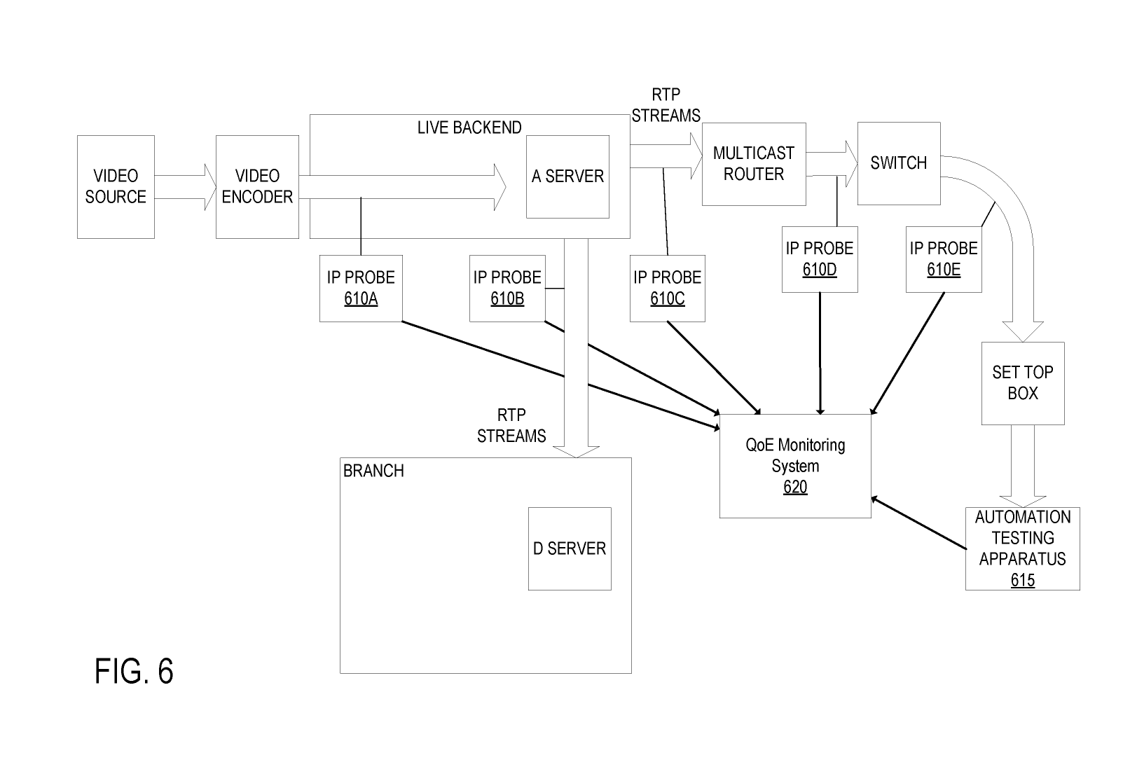

As previously described, in one embodiment the automation testing apparatus may be targeted at AV endpoints that decode an AV stream and utilize HDMI/HDCP to encapsulate the AV stream between an HDMI-compliant source endpoint designed to render video and the AV stream sourced from a managed or unmanaged network. In some embodiments the automation testing apparatus may be put in multiple locations in the network for quality-of-experience monitoring. For example, FIG. 6 illustrates an example of placing IP probes 610A-E among multiple places in the network, where each of the IP probes 610A-E is configured to capture data in the form of IP packets and send the captured IP packets to the QoE monitoring system 620 for analyzing the quality of experience of the captured AV stream at different points in the network. The automation testing apparatus 615 also transmits its results to the QoE monitoring system 620 for comparison.

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

Additionally, while the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. An automation testing apparatus, comprising:
a controller that is configured to receive a set of one or more commands and programmatically manipulate a set of components that connect the automation testing apparatus with a device under test (DUT) to test the DUT according to the set of commands;
the set of components including:
a power switch that is configured to turn on and off power to the DUT,
a communication controller that is configured to send commands to be executed by the DUT, and
an audio/video switch that is configured to turn on and off audio and/or video of the DUT; and
wherein the controller is further configured to log the set of commands executed and a result of execution of the set of commands

2. The automation testing apparatus of claim 1, wherein the set of components further include a camera controller that is configured to cause an image or video to be taken of a display connected to the DUT.

3. The automation testing apparatus of claim 2, wherein the image or video to be taken of the display connected to the DUT is provided in the log such that a user can visually confirm the image or video.

4. The automation testing apparatus of claim 3, wherein the log is provided to a server that is remote to the automation testing apparatus.

5. The automation testing apparatus of claim 1, wherein the communication controller is one of an Infrared controller, a Bluetooth controller, and a companion controller.

6. The automation testing apparatus of claim 1, wherein the audio/video switch is an HDMI switch that is configured to turn on and off an HDMI connection to the DUT.

7. The automation testing apparatus of claim 1, wherein the set of components further include a capture card that is configured to capture an audio/video (AV) stream being output by the DUT.

8. The automation testing apparatus of claim 7, wherein the capture card is further to separate the captured AV stream into a plurality of frames, and wherein the automation testing apparatus further includes an AV artifacts detection and analyzer that is configured to determine whether the captured AV stream is suffering from a loss of signal.

9. The automation testing apparatus of claim 1, wherein the set of one or more commands are received from a client over a network.

10. The automation testing apparatus of claim 1, wherein the set of one or more commands are generated from a test script.

11. A method for testing a device under test (DUT), comprising:
receiving a test command that is part of a test;
parsing the command to identify a type of the test command and which one of a plurality of components that are connected to the DUT to programmatically manipulate to execute the test command, wherein the plurality of components include:
a power switch that is operable to turn on and off power to the DUT,
a communication controller that is operable to send commands to be executed by the DUT, and
an audio/video switch that is operable to turn on and off audio and/or video of the DUT;
manipulating the identified one of the plurality of components to execute the received test command; and
logging the test command and a result of executing the received test command for analyzing whether the test passed.

12. The method of claim 11, wherein the plurality of components further includes a camera controller that is operable to cause an image or video to be taken of a display connected to the DUT.

13. The method of claim 12, further comprising: providing the image or video to be taken of the display connected to the DUT in the log such that a user can visually confirm the image or video.

14. The method of claim 13, further comprising: providing the log to a server.

15. The method of claim 11, wherein the communication controller is one of an Infrared controller, a Bluetooth controller, and a companion controller.

16. The method of claim 11, wherein the audio/video switch is an HDMI switch that is operable to turn on and off an HDMI connection to the DUT.

17. The method of claim 11, wherein the plurality of components further include a capture card that is operable to capture an audio/video (AV) stream being output by the DUT.

18. The method of claim 17, wherein the capture card is further operable to separate the captured AV stream into a plurality of frames, and further determining whether the captured AV streams is suffering from a loss of signal.

19. The method of claim 11, wherein the test command is received from a client over a network.

20. The method of claim 11, wherein the test command is generated from a test script.
